(19) United States
(12) Patent Application Publication
(10) Pub. No.: US 2026/0369483 A1
(43) Pub. Date: Nov. 19, 2026

(54) ELECTRIC CURRENT CONTACT WITH MOVABLE PAIRS OF CONTACT ELEMENTS

(71) Applicant: ABB Schweiz AG, Baden (CH)

(72) Inventors: Erik Jonsson Seither, Ranheim (NO); Nina Støa-Aanensen, Trondheim (NO); Maciej Mruczek, Skien (NO)

(21) Appl. No.: 19/679,990

(22) Filed: May 18, 2026

(30) Foreign Application Priority Data
May 19, 2025 (EP) 25177480.8

(51) Int. Cl. H01H 1/42

(52) U.S. Cl. CPC H01H 1/42

(57) ABSTRACT

The present disclosure relates to an electric current contact comprising[[:]] multiple contact elements arranged in opposing pairs , the pairs being stacked along a stacking direction and arranged to form a pocket between the contact elements of each pair, where the contact elements are configured to electrically engage with a movable contact lever in the pocket. The electric current contact further comprises at least one resilient member arranged to bias a movement of the contacts elements in each pair towards each other, and a retention assembly configured to maintain the stack of contact elements in a stacked arrangement while permitting relative movement between contact elements such that a width of the pocket is adjustable under the influence of the at least one resilient member.

### CROSS-REFERENCE TO RELATED APPLICATIONS

This application claims priority to European Patent Application No. 25177480.8, filed May 19, 2025 and titled “AN ELECTRIC CURRENT CONTACT WITH MOVABLE PAIRS OF CONTACT ELEMENTS”, the entire contents of which are herby incorporated by reference.

### TECHNICAL FIELD

The present disclosure relates to an electric current contact.

### BACKGROUND

Switching devices are fundamental components in electrical systems, used for connecting and disconnecting electrical circuits. These switches typically include a movable blade or knife member and a stationary contact. Reliable electrical connection and mechanical engagement between different parts of the switch is essential for proper operation. For example, misalignment between the blade and the stationary contact can lead to poor electrical contact, increased resistance, arcing, and premature wear.

There remains a need for an improved electric contact for knife or blade switches that can accommodate or correct misalignment during operation.

### BRIEF DESCRIPTION

In view of the above-mentioned and other drawbacks of the prior art, it is an object of the present disclosure to provide an electric current contact that at least partly alleviates the deficiencies with prior art.

According to a first aspect of the disclosure, there is provided an electric current contact comprising: multiple contact elements arranged in opposing pairs, the pairs being stacked along a stacking direction and arranged to form a pocket between the contact elements of each pair, the contact elements are configured to electrically engage with a movable contact lever in the pocket, at least one resilient member arranged to bias a movement of the contacts elements in each pair towards each other, a retention assembly configured to maintain the stack of contact elements in a stacked arrangement while permitting relative movement between contact elements such that a width of the pocket is adjustable under the influence of the at least one resilient member.

The present disclosure is at least partly based on the realization of forming the electric contact from pairs of contact elements that are mechanically separate structures that can move relative to each other. The pairs of contact elements can be considered to “float” such the pocket is adjustable for misalignments of the movable contact lever position and angle.

Furthermore, the at least one resilient member push the movable contact elements towards each other such that the opening side of the pocket is adjustable. The at least one resilient member is arranged such that if one contact element in a pair is pushed outwards, the other contact element in the same pair is pushed inwards, efficiently adapting the position of the pocket, matching the position of the knife.

The electric contact may be configured as a main contact or as an earth contact, or as a sliding contact.

In one embodiment, the electric current contact may comprise a spacer element stacked between each pair of contact elements in the stacking direction. The spacer ensures that the contact elements are not stacked directly onto each other, significantly limiting the current to flow directly from one contact element into another contact element. The spacer can be of an electric insulating material or metallic material with poor conductivity such as stainless steel. This advantageously facilitates individual movement of the contact elements, especially while being exposed to electromagnetic forces during making and breaking that push the stacked contact elements toward each other. The thickness of the spacer elements is, in some embodiments, less than the thickness of the contact elements.

In one embodiment, the retention assembly may comprise a first plate arranged at a first end of the stack, and a second plate arranged at second end of the stack. The first plate and the second plate form a cage holding the stacked, movable contact elements together. The first and second plates may be considered top plate and bottom plate.

In one embodiment, the electric current contact may comprise at least one elongated attachment member arranged in a through-hole of the top plate and in a through-hole of the bottom plate, to attach the top plate to the bottom plate with the contact elements between them. The elongated attachment members, such as bolts, provide a simple yet robust way to hold the floating contact elements in place.

In an embodiment, at least one elongated attachment member may be arranged through the pocket and at least one elongated attachment member may be arranged outside the pocket. With two spatially separated elongated attachment members, the top plate and the bottom plate are securely rotationally fixated with respect to each other.

In one embodiment, the first plate comprises a guiding slot configured to guide the contact lever into the pocket. The guiding slot advantageously steers the movable contact lever into the pocket in cases the contact lever is received in the electric contact for making contact. Furthermore, the first plate which may be considered a top plate may extend in front of the contact elements, thereby providing mechanical protection for the tips of the contact elements. The top plate with the guiding slot mechanical guides the movable contact lever into the pocket instead of the contact elements being responsible for the guiding. The top plate may be fork-shaped. The guiding slot may be slightly wider than the opening in the pocket.

In one embodiment, the electric current contact may comprise one resilient member for each pair of contact elements. The resilient member may be a resilient clip that is attached to clip onto to outer sides of the contact elements in the pair to biased them towards each other. This type of clip ensures a compact electric current contact that especially does not become excessively tall. The resilient clip may also be a leaf spring, as a further example.

In some embodiments, the clip may be attached from a rear side of the contact element opposite a receiving pocket where the tips of the contact elements are located.

In one embodiment, the contact elements may be elongated and comprise a front end portion, a rear end portion, wherein the front end portions jointly form the opening of the pocket.

In some embodiments, the resilient clips are attached from the rear end portion. However, in some embodiments, especially concerning a sliding connection, the clips may be attached from the front end portion.

In one embodiment, the contact elements may be movable with respect to the contact element in the respective pair, and with respect to contact elements of other pairs, to adjust for misalignments of the position and angle of the contact lever.

In one embodiment, the electric current contact may comprise at least three pairs of contact elements.

In one embodiment, each of the contact elements may be configured to be in electrically conductive contact with a main conductor at a rear end portion of the contact element opposite the pocket.

In one embodiment, the pocket may be a receiving pocket configured to receive the contact lever in a closed position.

The width of the receiving pocket is typically narrower than the width of the contact lever. For example, the width of the receiving pocket may be about 1 mm narrower than the width of the contact lever.

In the closed position of the movable contact lever, an electric current may pass between the contact lever, through the contact elements, and into the main contact conductor of the contact assembly. In the closed position, the movable contact lever is positioned in the receiving pocket. In the open position, the contact lever and the contact elements are not in contact whereby an electric current may not pass between them.

In one embodiment, each contact element comprises a bridge region configured to contact the bridge region of the other contact element of the respective pair to define a minimum opening width of the receiving pocket. The bridge region may be configured as a protrusion of the contact element that extends towards and onto the protruding bridge region of the other contact element in the same pair. When the contact elements are moved towards each other under the force from the at least one resilient member, the contact between the bridge regions limits further motion of the tips of the contact elements toward[[s]] each other, thereby ensuring a minimum opening width of the receiving pocket.

In other possible embodiments, the bridge region may be realized by a separate blocking element that is arranged between opposing contact elements in the pairs. The blocking element is configured to prevent the front tips from coming too close to each other and effectively define a minimum opening width of the receiving pocket.

In one embodiment, the electric current contact may comprise an arcing contact arranged on one end of the stack of contact element pairs, the arcing contact being biased by a resilient member towards the stack of contact element pairs. The resilient member serves to bias the arcing contact towards the position receiving pocket such that the arcing contact maintains good contact with the movable contact elver as it moves into the receiving pocket. The resilient member may be a leaf spring.

In one embodiment, arcing contact may be biased onto the top plate with the arcing coating area placed above and in front of the receiving pocket.

In some embodiments, the electrical engagement with the movable contact lever in the pocket is a sliding connection between the contact elements and the contact lever.

There is further provided an electric current switch comprising: a contact lever configured to rotate about a pivot point between a closed position and an open position, and at least one electric current contact according to any one of the herein described embodiments.

The electric current switch may be a blade or knife switch, whereby the movable contact lever may be blade or knife contact.

The electric current switch may be a medium voltage switch, for example in the range 1-52 kV. The electric current switch may be a gas insulated switchgear, for example for three-phase applications, working for example in natural origin gases, such as dry air, N2, O2, CO2 and/or mixture thereof.

Further features of, and advantages with, the present disclosure will become apparent when studying the appended claims and the following description. The skilled person realizes that different features of the present disclosure may be combined to create embodiments other than those described in the following, without departing from the scope of the present disclosure.

### BRIEF DESCRIPTION OF THE DRAWINGS

These and other aspects of the present disclosure will now be described in more detail, with reference to the appended drawings showing an example embodiment of the disclosure.

FIG. 1 illustrates an example electric current contact according to embodiments of the disclosure.

FIG. 2 is an exploded view of an example electric current contact according to embodiments of the disclosure.

FIG. 3 illustrates a pair of contact elements and a clip according to embodiments of the disclosure.

FIG. 4 illustrates a spacer according to embodiments of the disclosure.

FIG. 5 illustrates an electric current contact and a contact lever moving into a receiving pocket according to embodiments of the disclosure.

FIG. 6 illustrates a stack of contact elements according to embodiments of the disclosure.

FIG. 7 illustrates an example electric current switch according to embodiments of the disclosure.

FIG. 8 illustrates an electric contact according to an embodiment.

FIG. 9 is a close-up of the electric contact in FIG. 8.

### DETAILED DESCRIPTION

In the present detailed description, various embodiments of the present disclosure are herein described with reference to specific implementations. In describing embodiments, specific terminology is employed for the sake of clarity. However, the disclosure is not intended to be limited to the specific terminology so selected. While specific exemplary embodiments are discussed, it should be understood that this is done for illustration purposes only. A person skilled in the relevant art will recognize that other components and configurations can be used without parting from the scope of the disclosure.

Single knife or blade type switches may suffer from high electrodynamic repulsion forces during short-time current making and breaking scenarios if the number of contact spots is not carefully considered. Increasing the number of contact spots may overcome this issue but may instead give rise to more complex mechanical structure with other problems such as increased cost and manufacturing challenges. Furthermore, the contact also needs to allow for misalignment issues of the single knife or blade in the contact.

The present disclosure describes an electric current contact which includes a multiple contact element arrangement where the contact elements are arranged in pairs and that can move relative each other. This provides multiple contacts spots while the movable, or “floating”, contact elements compensate for misalignment of the contact lever.

The electric current contact can be configured to receive a movable contact lever in a receiving pocket.

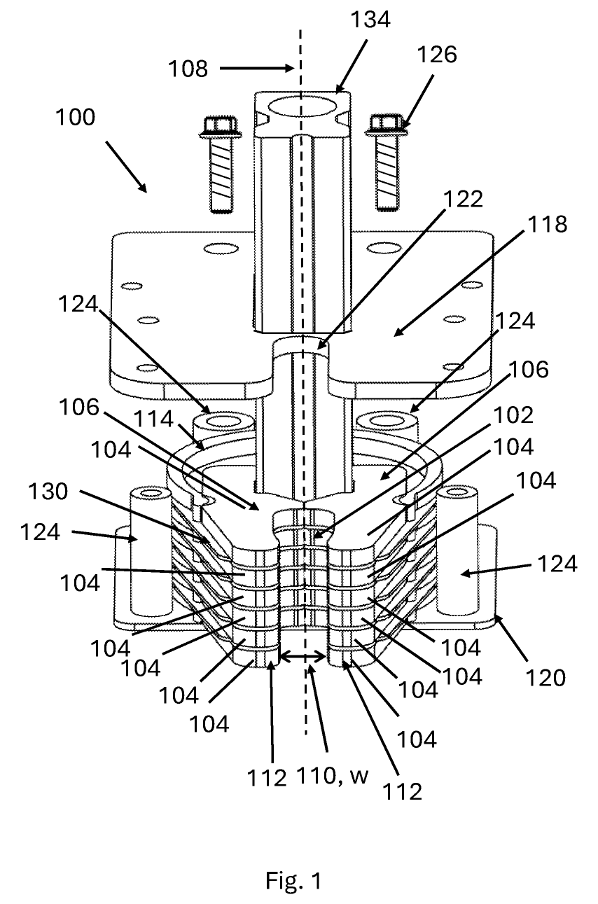

FIG. 1 is an electric current contact 100 according to an example embodiment. The electric current contact 100 is configured to receive a mating movable contact lever in a receiving pocket 102.

The electric current contact comprises multiple contact elements 104 arranged in pairs 106, where only one pair 106 is denoted in FIG. 1. The pairs are stacked in a stacking direction along an axis 108 and are arranged to form a receiving pocket 102 between the contact elements 104 of each pair 106. The pairs 106 comprise two contact elements in the same vertical position in the stack.

The contact elements 104 are configured to receive and electrically engage with a mating movable contact lever in the receiving pocket 102. The movable contact lever is received through an opening 110 of the pocket 102. The width w of the opening is between the tips 112 of the contact elements 104. The height of the receiving pocket is from the bottom pair to the top pair along the stacking axis 108 of the contact element pairs.

At least one resilient member 114 is arranged to bias a movement of the contact elements 104 in each pair 106 towards each other. The at least one resilient member 114 is here shown as a clip 114. The clip 114 is configured to push the contact elements 104 in each pair towards each other such that the width w of the opening, and the size of the receiving pocket 102 is adjustable individually for each of the pairs 106. Thus, the contact elements 104, or equally termed contact fingers 104 are mechanically separate structures that can move relative to each other.

A retention assembly 118, 120 is configured to maintain the stack of contact elements 104 in a stacked arrangement while permitting relative movement between contact elements 104 such that a width w of the receiving pocket is adjustable under the influence of the at least one resilient member 114.

The retention assembly comprises a top plate 118 arranged at a first end of the stack and a bottom plate 120 arranged at second end of the stack.

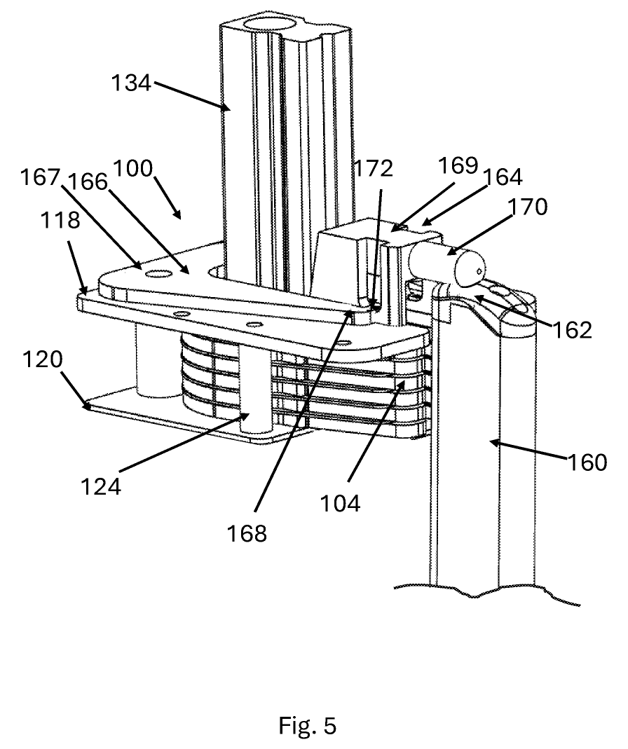

The top plate 118 comprises a guiding slot 122 configured to guide the contact lever into the receiving pocket 102. The guiding slot 122 is somewhat wider compared to the thickness of the contact lever (shown in FIG. 5).

The top plate 118 and the bottom plate 120 are separated by distance bushings 124 that ensure enough space between the top plate 118 and the bottom plate 120 to allow the contact elements 104 to be movable between them. Elongated attachment members 126 are arranged in through-holes of the top plate 118 and in through-holes of the bottom plate 120 and through the bushings 124, to attach the top plate to the bottom plate with the contact elements between them. The retention assembly with the top plate 118, bottom plate 120, the bushings 124, and the elongated attachment members 126 (only two are shown) form a cage structure for holding the stack of contact elements 104 in place while at the same time allowing for relative movement between them. Advantageously, this avoids the need for pins or similar elements to penetrate through the contact elements 104 to hold them in place. Instead, the top plate, the bottom plate and the elongated members 126 for a cage that holed the stack of contact elements 114 in place but still allow them to move, that is, float, with respect to each other inside the cage structure.

A spacer element 130 is stacked between each pair of contact elements 104 in the stacking direction to facilitate the movement of the contact elements 104, especially since high electric currents may force the contact elements towards each other which reduces their ability to move.

The example embodiment shown in FIG. 1 comprises six pairs of contact elements 104. This means that the electric current contact 100 has twelve contact spots, one for each contact element 104, that share the electric current. In some embodiments, the contact element comprises at least three pairs of contact elements 104.

The stacked pairs 106 of contact elements 104 may be considered arranged in a lamella structure.

Each of the contact elements 104 is configured to be in electrically conductive contact with a main conductor 134 at a rear end portion of the contact element opposite the receiving pocket 102. The main conductor 134 is typically a copper-based conductor.

The contact elements 104, in some embodiments, comprise or are made from copper.

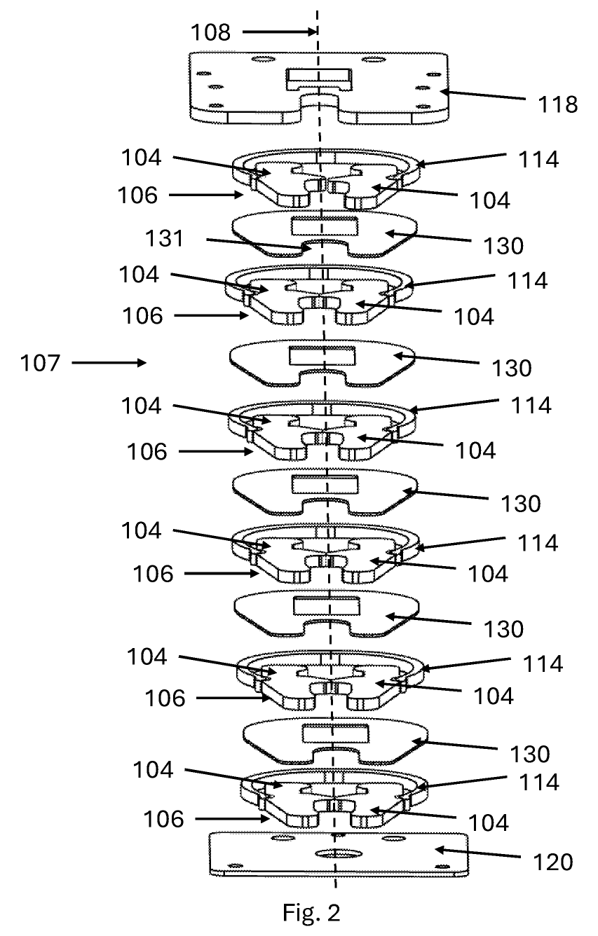

FIG. 2 is an exploded view of the stack 107 of pairs 106 of contact elements 104. The pairs 106 are each arranged as a separate layer in the stack 107 such that they jointly form the receiving pocket 102. Interleaved between each of the neighboring pairs 106 is a spacer 130 arranged to facilitate relative motion between neighboring contact elements 104 in the stack 107. The spacer 130 is thin compared to the contact elements 104 and is typically about 0.5 mm thick, in the stacking direction 108. The spacer 130 may be non-magnetic such as made from stainless steel.

The thickness of the contact elements 104 in the stacking direction is typically in the range of 1 mm to 5 mm, such as about 2.5 mm.

In some embodiments, there is one resilient member 114, clip 114, for each pair 106 of contact elements 104. This facilitates individual movement and adjustment of the contact elements 104 to compensate for misalignment of the movable contact lever.

The spacers 130 comprise a cut-out 131 to free the space in the receiving pocket.

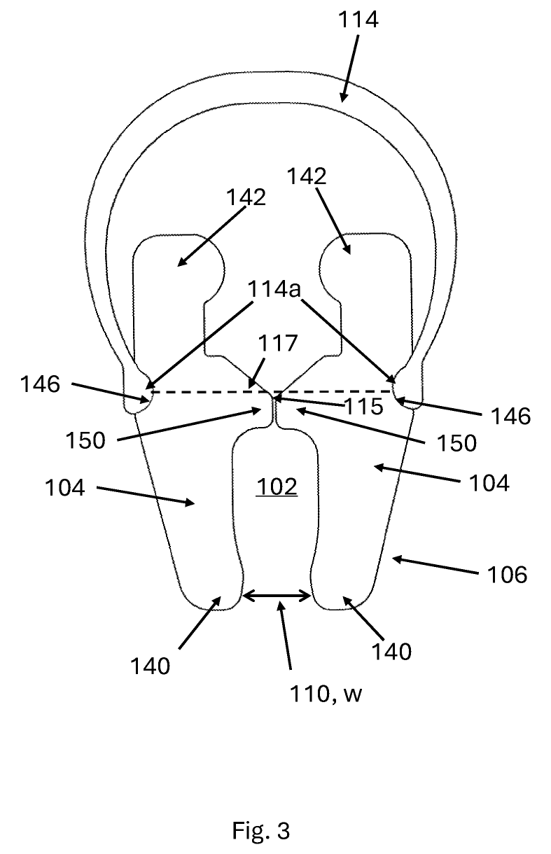

FIG. 3 is a top-view of a pair 106 of contact elements 104. The clip 114 clamps the contact elements 104 together by a spring-force. The contact elements 104 are elongated and comprise a front end portion 140, a rear end portion 142. The front end portions 140 collectively form the opening 110 of the receiving pocket 102.

The clip 114 comprises bulging end portions 114a that sit in receiving holes 146 or grooves or pockets on the sides of the contact elements 104. The clip 114 snaps into place into the holes 146 due to its resilient force that biases the contact elements 104 towards each other. The clip 114 is arranged at the rear end portions 142 of the contact elements 104 which advantageously avoids adding height to the stack 107.

Each contact element 104 comprises a bridge region 150 configured to contact the bridge region 150 of the other contact element 104 of the respective pair 106 to define a minimum opening width w of the receiving pocket 102. The bridge region which is between the front end portion 140 and the rear end portion 142 is a protrusion that extends towards the other contact element 104 in the pair 106. The bridge regions 150 of the two contact elements come in contact under the force from the clip 114, and once in contact, the front end portions 140 does not approach each other further. This ensures a minimum width of the opening 110 of the receiving pocket which is somewhat less than the width of a knife or blade contact lever it receives.

The clip 114 is arranged with its end portions 114a slightly towards the rearwards of the bridge regions 150, as indicated by the dashed line 117 being rearwards of the end parts 115 of the bridge regions 150. This ensures that the opening 110 remains open even if the contact lever is not in the pocket 102. Furthermore, this allows the rear end of the contact elements to pinch on the main conductor 134 (see, for example, FIG. 1). When the contact lever enters the pocket, the clip 114 biases the front ends 140 of the contact elements 104 towards each other and onto the contact lever.

The contact elements 104 are identical which facilitates manufacturing of the electric current contact. The contact elements 104 can for example be made using a punching operation which enables making a large number of contact elements in a short time period. Similarly, the spacers and the top and bottom plates may also be made using a punching operation , creating a cost-effective solution for manufacturing the electric current contact. This further allows the configuration to be varied easily. For example, six pairs 106 of contact elements can be selected for a 630 A product and 4 pairs 106 for another electric current contact rated for less current, but still using the same type of parts. Advantageously, the clips 114 may also be made using a punching operation .

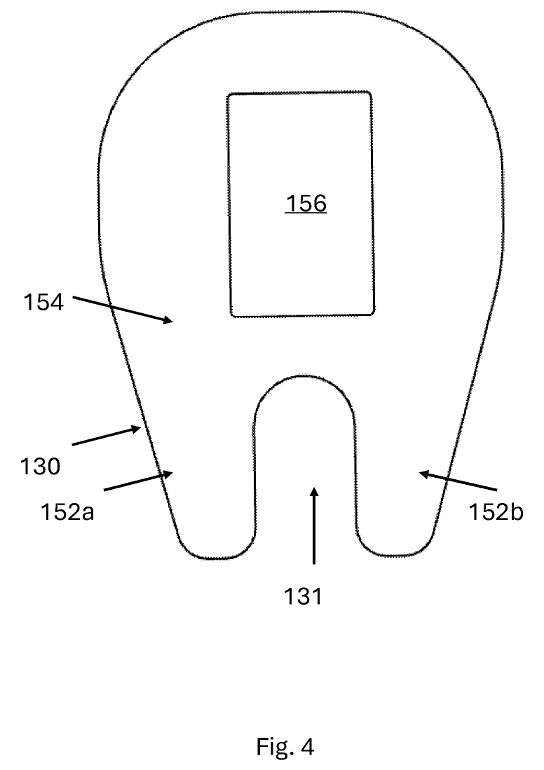

FIG. 4 is a top view of a spacer 130. The spacer 130 comprises two legs 152a,b joined at a base 154. The cut-out or groove 131 is formed between the legs and allows for the receiving pocket 102 to be located between the legs and between the contact elements. The contact elements 104 are substantially aligned with the legs 152a,b. The spacer 130 further comprises a through-hole 156 through which the main contact conductor 134 is arranged, see, for example, FIG. 1.

FIG. 5 illustrates the electric current contact 100 and a contact lever 160 moving into the receiving pocket 102. The contact lever 160 comprises an arcing area 162 at an end portion of the lever 160. The electric current contact 100 comprises an arcing contact 164 arranged on one end of the stack of contact element pairs 106. A resilient member 166, here a leaf spring 166 biases the arcing contact 164 towards the stack of contact element pairs. The leaf spring 166 is fixated at its rear end 167, and movable at its front end 168.

The arcing contact 164 comprises a holder 169 and an arcing pin 170 held by the holder 169. The front end 168 of the leaf spring 166 rests on an edge or is attached to the holder 168 with the leaf spring 166 biased to, for example, push or hold or preload the holder 169 against the top plate 118. The holder 169 has two small protrusions or “foots” sticking down into the top plate 118, making it stay in place and rotate upwards during contact making.

When the contact lever 160 moves into the receiving pocket 102, the arcing area 162 comes in contact with the arcing pin 170 and push the arcing contact 164 upwards, against the force provided by the leaf spring 166. In this way, the arcing contact 164 can absorb misalignment in the height position of the contact lever 160 of at least one or a few millimeters.

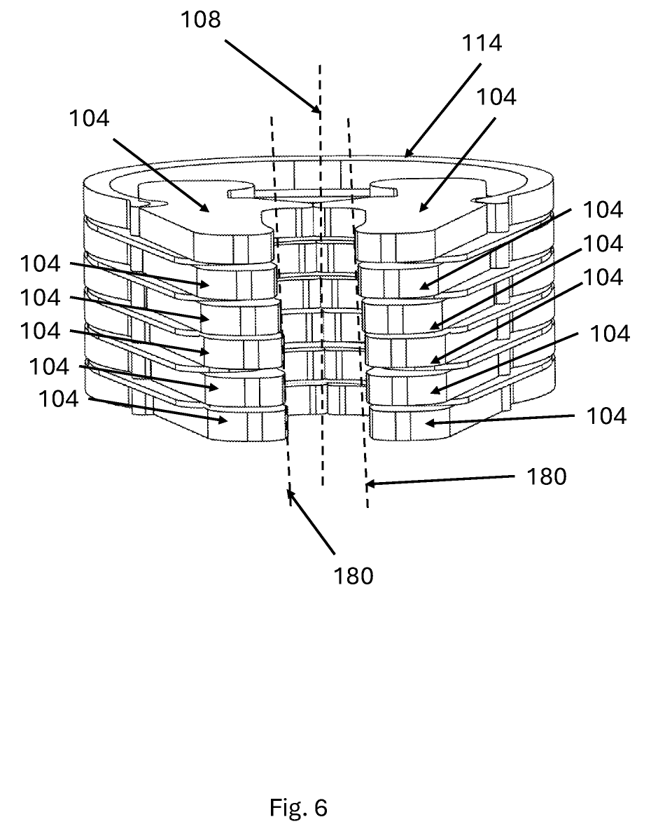

FIG. 6 illustrates positions of the contact elements 104 where the contact elements have moved with respect to each other. That is, the front ends of the contact elements 104 are no longer aligned with the longitudinal stacking axis 108 as indicated by the inclined dashed lines 180. The contact elements 104 are movable with respect to the contact element in the respective pair, and with respect to contact elements of other pairs, to adjust for misalignments of the position and angle of the contact lever.

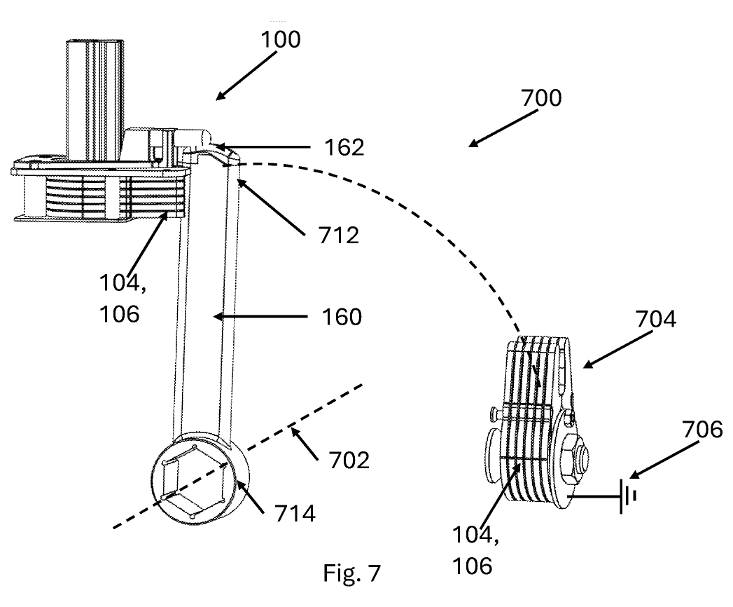

FIG. 7 illustrates an electric current switch 700 comprising contact lever 160 configured to rotate about a pivot point between at least a closed position and an open position. The electric current switch 700 comprises an electric current contact 100 as described in any of the herein exemplified embodiments, configured to receive the movable contact lever in a closed position.

In the closed position, the contact lever 160 is in contact with the pairs 106 of contact elements 104 in the receiving pocket 102 of the electric current contact 100.

In the open position, the contact lever 160 is not in contact with the pairs 106 of contact elements 104 in the receiving pocket 102 of the electric current contact 100.

The contact lever 160 is rotatable about an axis 702 between the closed position and the open position, and further to and from an earth position where the contact lever 160 is connected to the earth contact 704.

The contact lever 160 comprises a proximal end 712 and a distal end 714.

The earth contact 704 comprises the same arrangement of contact elements 104 in pairs 106 as the electric contact 100. That is, an electric contact 100 as described herein may also serve as an earth contact 704 connected to electrical ground 706.

The contact lever 160 may be a bar of copper optionally with a protecting CuW insert 162 as arcing contact area. The contact lever may be about 3 mm to 20 mm thick at the main contact area. The contact lever thickness is oriented in the direction perpendicular to the rotation plane of the knife or blade. In one embodiment, the thickness of the knife or blade at the main contact area is about 8 mm.

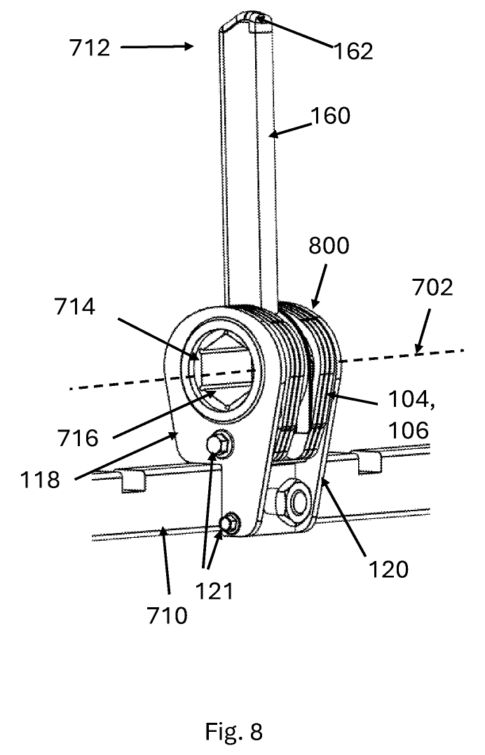

FIG. 8 illustrates an electric contact 800 according to an embodiment where the electrical engagement with the movable contact lever 160 in the pocket is a sliding connection between the contact elements 104 and the contact lever 160.

As described with reference to FIG. 7, The contact lever 160 is rotatable about an axis 702 between the closed position and the open position, and possibly further to and from an earth position where the contact lever 160 is connected to the earth contact 704. The proximal end 712 of the contact lever 160, with the arcing tip 164, moves into electric engagement with the main contact 100 and the earth contact 704. The opposite end of the contact lever, the distal end 714 comprises a through-hole 716 for engagement with a shaft for rotation of the contact lever 160. Furthermore, electrical connection with a bar 710 is provided through sliding electrical connection between the contact elements 104 of the electrical contact 800 and the distal end 714 of the contact lever 160.

The stack of contact elements 104 are held in place by plates 118 and 120 attached to each other through elongated connection members 121, for example, bolts and nuts, as described above. The plates 118, 120 has through-holes to allow for the shaft to reach the through-hole 716 of the contact lever 160.

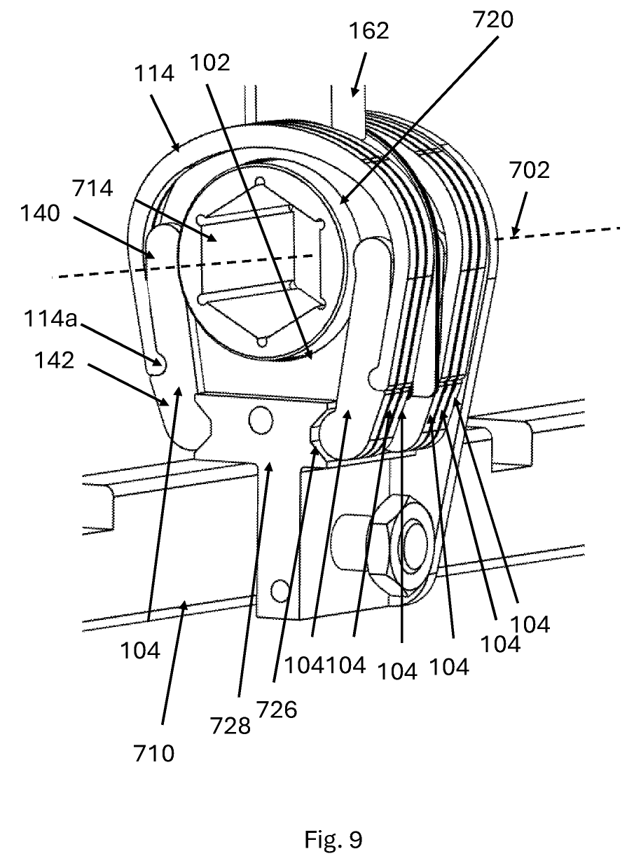

FIG. 9 is a close-up of the electric contact 800 with the plates 118 and 120 removed.

The resilient members 114, one for each pair 106 of contact elements 104, are attached from the front end 140 of the contact elements. The clips 114 maintain the contact elements 104 in electrical engagement with the distal end 714 of the contact lever 160 when the contact lever 162 rotates about the axis 702. The distal end 714 of the contact lever 162 comprises an outwards facing surface 720 configured to receive the contact elements 104. The surface 720 is part of the substantially circular or cylindrical distal end 714 of the contact lever 160.

The clips 114 clamp the contact elements 104 of their respective pair against the outwards facing surface 720 and maintains the engagement therebetween as the contact lever 162 rotates. Misalignment of irregularities of the distal end 714 and its surface 720 are compensated for by the adjustable pocket 102 due to the movable of the contact elements 104 which adjust their position based on the shape and movement of the contact lever 160 distal end 714.

The rear ends 142 of the contact elements 104 are accommodated in a receiving socket 726 of a connection part 728. The socket 726 is rounded to allow for rotation of the contact elements 104 about their rear ends 142 under the influence of the clips 114. The connection part 728 provides electrical connection between the contact elements 104 and the bar 710. The connection part 728 is bolted to the bar 710.

Even though the disclosure has been described with reference to specific exemplifying embodiments thereof, many different alterations, modifications and the like will become apparent for those skilled in the art.

Additionally, variations to the disclosed embodiments can be understood and effected by the skilled person in practicing the claimed disclosure, from a study of the drawings, the disclosure, and the appended claims. In the claims, the word "comprising" does not exclude other elements or activities, and the indefinite article "a" or "an" does not exclude a plurality. The mere fact that certain measures are recited in mutually different dependent claims does not indicate that a combination of these measures cannot be used to advantage.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An electric current contact comprising:
multiple contact elements arranged in opposing pairs the pairs stacked along a stacking direction and arranged to form a pocket between the contact elements of each pair, wherein the contact elements are configured to electrically engage with a movable contact lever in the pocket ;
at least one resilient member arranged to bias a movement of the contacts elements in each pair towards each other; and
a retention assembly configured to maintain the stack of contact elements in a stacked arrangement while permitting relative movement between contact elements such that a width of the pocket is adjustable under an influence of the at least one resilient member.

2. The electric current contact according to claim 1, further comprising a spacer element stacked between each pair of contact elements in the stacking direction.

3. The electric current contact according to claim claim 1 wherein the retention assembly comprises a first plate arranged at a first end of the stack, and a second plate arranged at second end of the stack.

4. The electric current contact according to claim 3, wherein the first plate comprises a guiding slot configured to guide the movable contact lever into the pocket.

5. The electric current contact according to claim claim 1 further comprising one resilient member for each pair of contact elements.

6. The electric current contact according to claim claim 1 wherein the contact elements are elongated and each comprises a front end portion a rear end portion and wherein the front end portions collectively form an opening of the pocket.

7. The electric current contact according to claim claim 1 wherein the contact elements are movable with respect to the contact element in the respective pair, and with respect to contact elements of other pairs, to adjust for misalignments of a position and an angle of the movable contact lever.

8. The electric current contact according to claim claim 1 further comprising at least three pairs of contact elements.

9. The electric current contact according to claim claim 1 wherein each of the contact elements are configured to be in electrically conductive contact with a main conductor at a rear end portion of the contact element opposite the pocket.

10. The electric current contact according to claim claim 1 wherein the pocket is a receiving pocket configured to receive the movable contact lever in a closed position.

11. The electric current contact according to claim 10, wherein each contact element comprises a bridge region configured to contact the bridge region of the other contact element of the respective pair to define a minimum opening width of the receiving pocket.

12. The electric current contact according to claim claim 1 further comprising an arcing contact arranged on one end of the stack of contact element pairs, the arcing contact biased by a resilient member towards the stack of contact element pairs.

13. The electric current contact according to claim 12, wherein the arcing contact is biased onto a top plate.

14. The electric current contact according to claim claim 1 wherein an electrical engagement with the movable contact lever in the pocket is a sliding connection between the contact elements and the movable contact lever.

15. An electric current switch comprising:
a movable contact lever configured to rotate about a pivot point between a closed position and an open position; and
at least one electric current contact comprising:
multiple contact elements arranged in opposing pairs, the pairs stacked along a stacking direction and arranged to form a pocket between the contact elements of each pair, wherein the contact elements are configured to electrically engage with the movable contact lever in the pocket;
at least one resilient member arranged to bias a movement of the contacts elements in each pair towards each other; and
a retention assembly configured to maintain the stack of contact elements in a stacked arrangement while permitting relative movement between contact elements such that a width of the pocket is adjustable under an influence of the at least one resilient member.

16. The electric current switch according to claim 15, wherein the at least one electric current contact further comprises a spacer element stacked between each pair of contact elements in the stacking direction.

17. The electric current switch according to claim 15, wherein the retention assembly comprises a first plate arranged at a first end of the stack, and a second plate arranged at second end of the stack.

18. The electric current switch according to claim 17, wherein the first plate comprises a guiding slot configured to guide the movable contact lever into the pocket.

19. The electric current switch according to claim 15, further comprising one resilient member for each pair of contact elements.

20. The electric current switch according to claim 15, wherein the contact elements are elongated and each contact element comprises a front end portion, a rear end portion, and wherein the front end portions jointly form an opening of the pocket.
